(19) United States
(12) Patent Application Publication
(10) Pub. No.: US 2008/0180571 A1
(43) Pub. Date: Jul. 31, 2008

(54) Method and Related Apparatus for Hiding Data Inside Video Signals and Transmitting the Video Signals to a Display Device

(76) Inventor: Liang-Shing Chuang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/023,043

(22) Filed: Jan. 31, 2008

(30) Foreign Application Priority Data
Jan. 31, 2007 (TW) 096103545

(51) Int. Cl. H04N 7/00

(52) U.S. Cl. 348/461; 348/E07.001

(57) ABSTRACT

A method that hides data inside video signals and transmits the video signals to a display device, the method includes detecting whether a signature signal is attached to a window frame, picking the signature signal from the window frame when detecting the signature signal is attached to the window frame, generating a control signal according to the signature signal, and acting correspondingly on the display device according to the control signal.

### BACKGROUND OF THE INVENTION

1. Field of the Invention

The present invention relates to a method and related apparatus for hiding data inside video signals and transmitting the video signals to a display device, and more particularly, to a method and related apparatus utilizing a signal filter to pick the data from the video signals.

2. Description of the Prior Art

With popularization of computer devices, associated computer technology has been quickly developed to improve functionality and convenience of computer devices. Recently, operating speeds of a central processing unit (CPU) have already exceeded three gigahertz (GHz), and the computer devices have powerful data processing capability now. Therefore, normal users do not merely view the computer devices as great helpers for work. The computer device increasingly becomes one of the entertainment facilities at home. In addition, with development and application of well-known multimedia technology, monitors and graphics cards of computer devices responsible for outputting videos become a major factor when consumers purchase computer devices. Generally speaking, in order to conform to a plug and play (PNP) specification, the monitor has a display data channel/command interface (DDC/CI) used to establish communication between a host of the computer device and the monitor of the computer device. That is, the monitor is capable of directly transferring its own hardware specification to the graphics card within the host. Therefore, the graphics card then acknowledges the hardware specification of the monitor. For example, the hardware specification includes maximum horizontal scanning frequency, the maximum vertical refresh rate, etc.

Please refer to FIG. 1. FIG. 1 is a diagram illustrating data exchange between a host and a display device of a computer system 10 in the prior art. The computer system includes a host 14 and a display device 12. The host 14 includes a central processing unit 15 and a VGA adapter 16. The central processing unit 15 is used for controlling operations of the computer system 10. The VGA adapter 16 is used for processing image data desired to be displayed and transmitting it to the display device 12 for displaying it. The central processing unit 15 and the VGA adapter 16 transmit data through a bus, such as a PCI (peripheral component interconnect) bus or an AGP (accelerated graphic port) bus. The image data processed by the VGA adapter 16 will be transmitted to the display device 12 through the DDC/CI interface, and the VGA adapter 16 can also access data from the display device 12 through the DDC/CI interface. The DDC/CI interface is used for building a communication channel between the host 14 and the display device 12. The image data from the VGA adapter 16 of the host 14 is always outputted through an analog visual interface (such as D-sub) or a digital visual interface (DVI) and is transmitted through a transmission cable to the display device 12 to be displayed.

### SUMMARY OF THE INVENTION

The claimed invention provides a method for hiding data inside video signals and transmitting the video signals to a display device. The method includes detecting whether a signature signal is attached to a window frame, picking the signature signal from the window frame when detecting that the signature signal is attached to the window frame, generating a control signal according to the signature signal, and acting correspondingly on the display device according to the control signal.

The claimed invention provides a display device that hides data inside video signals. The display device includes a signal filter and a microprocessor. The signal filter has an input end for receiving a window frame and picking a signature signal from the window frame. The microprocessor has an input end coupled to a first output end of the signal filter and an output end for outputting a control signal according to the signature signal. The display device acts correspondingly according to the control signal. The display device further includes a scaler. The scaler has a first input end coupled to a second output end of the signal filter for receiving the control signal, and an output end used for generating a display signal. The scaler is used for selectively processing size adjustment or image setting according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating data exchange between a host and a display device of a computer system in the prior art.

FIG. 2 is a diagram showing a computer system that hides data inside video signals and transmits the video signals to a display device according to an embodiment of the present invention.

FIG. 3 is a diagram of flow illustrating a method for hiding data inside video signals and transmitting the video signals to a display device according to an embodiment of the present invention.

FIG. 4 is a diagram illustrating the location filter in FIG. 3.

FIG. 5 is a diagram illustrating the space hiding filter in FIG. 3.

FIG. 6 is a diagram illustrating the watermark filter in FIG. 3.

FIG. 7 is a diagram illustrating the temporary filter in FIG. 3.

FIG. 8 is a diagram illustrating the repetition filter in FIG. 3.

### DETAILED DESCRIPTION

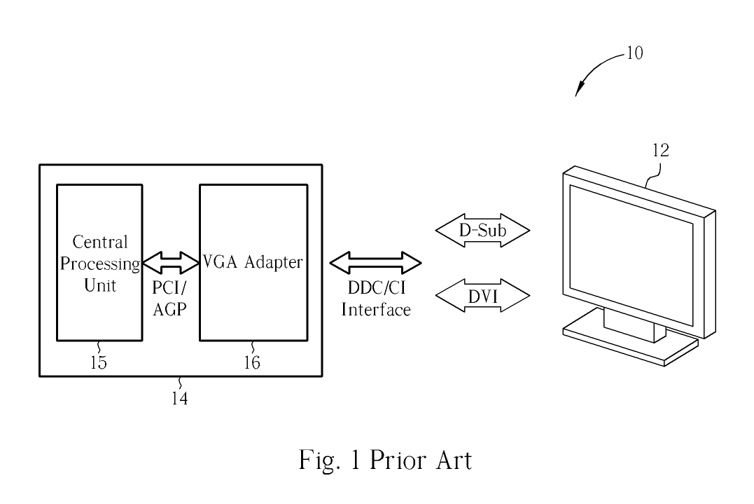

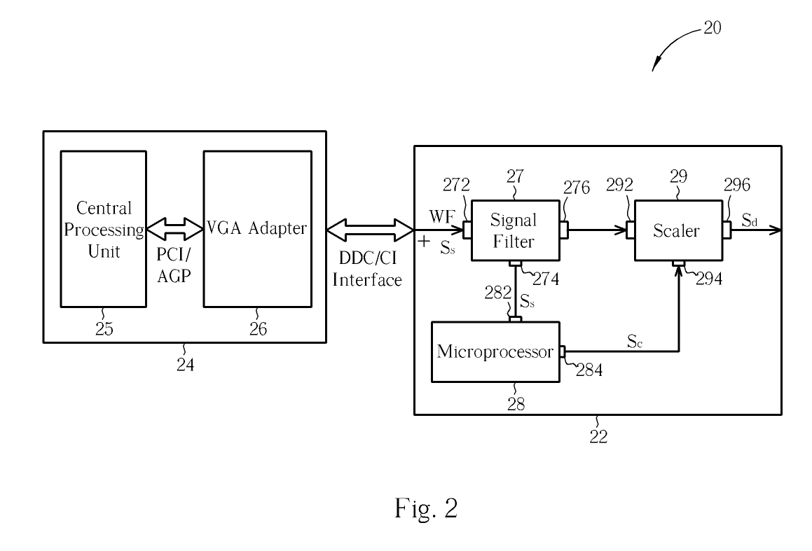

Please refer to FIG. 2. FIG. 2 is a diagram showing a computer system 20 that hides data inside video signals and transmits the video signals to a display device according to an embodiment of the present invention. The computer system 20 includes a host 24 and a display device 22. The host 24 includes a central processing unit 25 and a VGA adapter 26. The central processing unit 25 and the VGA adapter 26 are totally the same as the central processing unit 15 and the VGA adapter 16 in FIG. 1, which is not explained anymore. The VGA adapter 26 is used for processing image data desired to be displayed and transmitting it to the display device 22 for displaying it. The image data processed by the VGA adapter 26 will be transmitted to the display device 22 through the DDC/CI interface, and the VGA adapter 26 can also access data from the display device 22 through the DDC/CI interface. The DDC/CI interface is used for building a communication channel between the host 24 and the display device 22.

Please keep referring to FIG. 2. The display device 22 includes a signal filter 27, a microprocessor 28, and a scaler 29. The signal filter 27 has an input end 272, a first output end 274, and a second output end 276. The input end 272 is used for receiving a window frame WF, and a signature signal Ss is hidden in the window frame WF. The signal filter 27 obtains the signature signal Ss according to the window frame WF. The microprocessor 28 has an input end 282 and an output end 284. The input end 282 is coupled to the first output end 274 of the signal filter 27 for receiving the signature signal Ss, and the output end 284 is used for generating a control signal Sc according to the received signature signal Ss. The scaler 29 has a first input end 292, a second input end 294, and an output end 296. The first input end 292 is coupled to the second output end 276 of the signal filter 27 for receiving the window frame WF, the second input end 294 is coupled to the output end 284 of the microprocessor 28 for receiving the control signal Sc, and the output end 296 is used for generating a display signal Sd. The scaler 29 is used for selectively processing size adjustment or image setting. The display device 22 acts correspondingly according to the control signal Sc, such as executing commands for processing size adjustment, image setting, and turning on/off display frame. In addition, the control signal Sc can directly control the display device 22 without passing through the scaler 29, for example, adjusting luminance or adjusting volume. The signal filter 27 can be a location filter, a space hiding filter, a watermark filter, a temporary filter, or a repetition filter, which will be explained in the following embodiments.

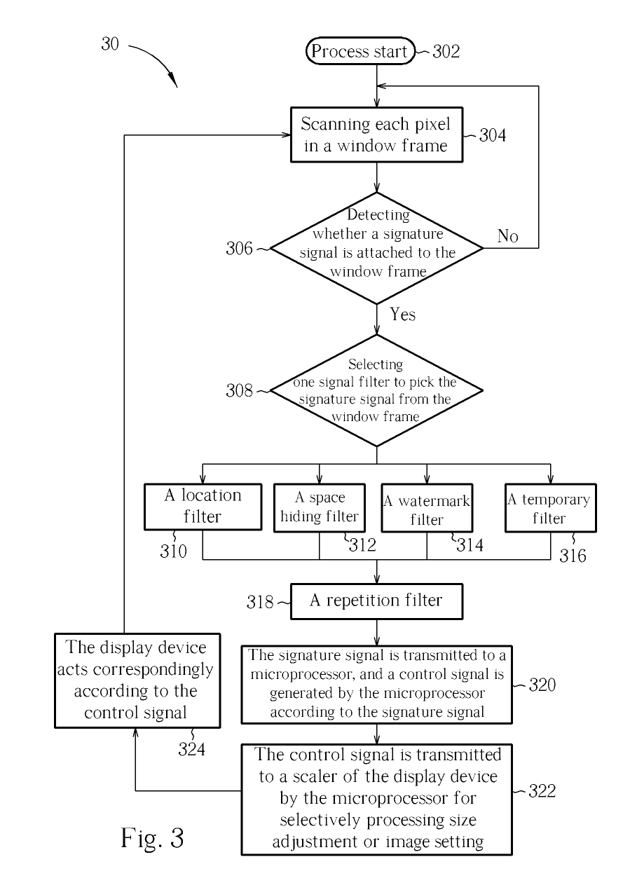

Please refer to FIG. 3. FIG. 3 is a diagram of flow 30 illustrating a method for hiding data inside video signals and transmitting the video signals to a display device according to an embodiment of the present invention. The flow 30 includes the following steps:

Step 302: Process start.

Step 304: Scan each pixel in a window frame.

Step 306: Detect whether a signature signal is attached to the window frame.

Step 308: Select one signal filter to pick the signature signal from the window frame.

Step 310: Utilize a location filter to pick the signature signal from the window frame.

Step 312: Utilize a space hiding filter to pick the signature signal from the window frame.

Step 314: Utilize a watermark filter to pick the signature signal from the window frame.

Step 316: Utilize a temporary filter to pick the signature signal from the window frame.

Step 318: Utilize a repetition filter to discard an image information with repetition number when receiving the image information with repetition.

Step 320: The picked signature signal is transmitted to a microprocessor, and a control signal is generated by the microprocessor according to the signature signal.

Step 322: The control signal is transmitted to a scaler of the display device by the microprocessor for selectively processing size adjustment or image setting.

Step 324: The display device acts correspondingly according to the control signal.

In step 306-308, a signal filter is selected to pick the signature signal from the window frame when detecting the signature signal is attached to the window frame. When detecting the signature signal is not attached to the window frame, continue detecting whether the signature signal is attached to a next window frame (back to step 304). In step 310-316, the location filter, the space hiding filter, the watermark filter, and the temporary filter are respectively utilized to pick the signature signal from the window frame. In step 318, the repetition filter is used for discarding the image information with repetition number when receiving the image information with repetition. The microprocessor generates the control signal and transmits it to the display device according to the signature signal, and then the display device acts correspondingly according to the control signal (step 320-324). After finishing detections of the window frame, continue detecting whether the signature signal is attached to a next window frame.

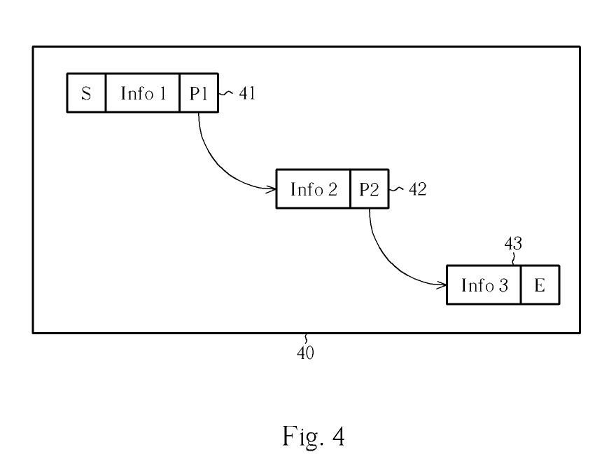

Please refer to FIG. 4 and FIG. 3. FIG. 4 is a diagram illustrating the location filter in FIG. 3. As shown in FIG. 4, the signature signal is divided into three segments, which are distributed in different locations in a window frame 40. In the window frame 40, the present invention can detect a first notation 41 in a first location. The first notation 41 includes a specific sign S, a first information Info1, and a first pointer P1, where the first pointer P1 is used for indicating a second location of a second notation 42. And then the present invention can find out the second location in the window frame 40 to obtain the second notation 42 according to the first notation 41. The second notation 42 includes a second information Info2 and a second pointer P2, whereof the second pointer P2 is used for indicating a third location of a third notation 43. Finally, the present invention can find out the third location in the window frame 40 to obtain the third notation 43 according to the second notation 42. The third notation 43 includes a third information Info3 and an end sign E. The first notation 41, the second notation 42, and the third notation 43 form the signature signal.

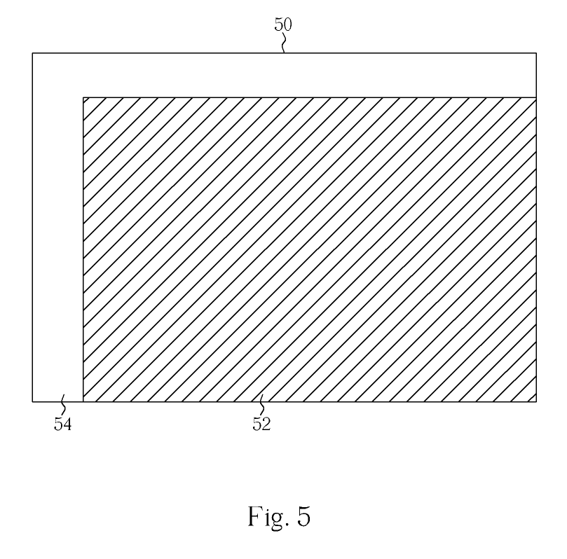

Please refer to FIG. 5 and FIG. 3. FIG. 5 is a diagram illustrating the space hiding filter in FIG. 3. A window frame 50 includes a visible region 52 and an invisible region 54. Generally speaking, if a size of the whole window frame 50 is 1320×1050 (pixels), the visible region 52 occupies 1280×1024 and all the other portions belong to the invisible region 54. Thus the signature signal can be hidden in the invisible region 54 and transmitted together, which will not influence the frame seen by users.

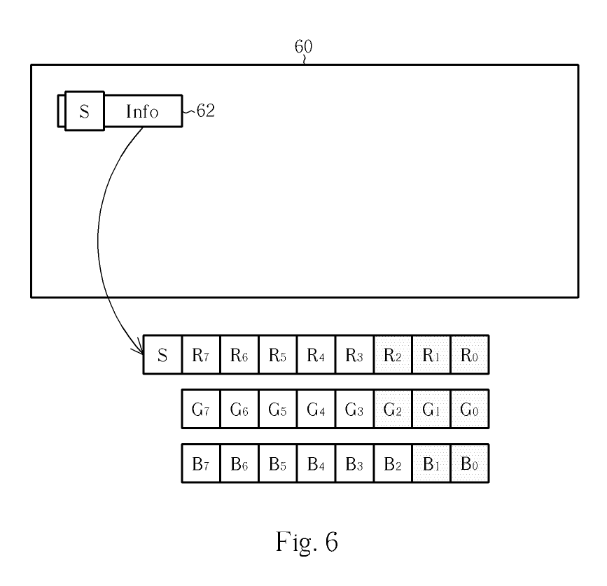

Please refer to FIG. 6 and FIG. 3. FIG. 6 is a diagram illustrating the watermark filter in FIG. 3. As shown in FIG. 6, a window frame 60 desires to transmit a pixel 62, whereof the pixel 62 includes a specific sign S and an information Info. A pixel is usually composed of three signals R, G, and B, where the three signals R, G, and B each includes a byte R₀-R₇, G₀-G₇, and B₀-B₇. Assume that the signature signal is 8 bits, then the signature signal can be put into the last three bits (R₀-R₂) of the signal R, the last three bits (G₀-G₂) of the signal G, and the last two bits (B₀-B₁) of the signal B, which totally are 8 bits. Due to the signature signal being hidden in the last significant bit (LSB) of three bytes of a pixel, there is no huge effect on the original signal content.

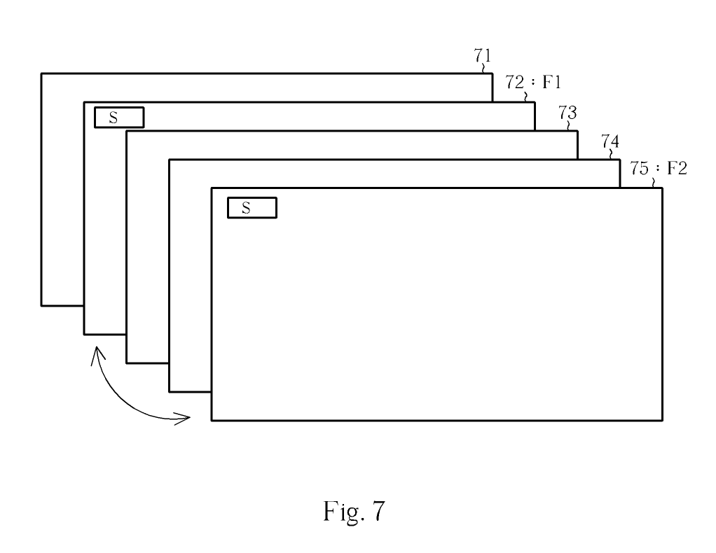

Please refer to FIG. 7 and FIG. 3. FIG. 7 is a diagram illustrating the temporary filter in FIG. 3. The specific sign S is sent out according to a designed frequency when a lot of data are transmitted to the display device. When the display device detected the specific sign S, the window frame is decoded to obtain the specific sign S according to the designed frequency. As shown in FIG. 7, a plurality of window frames 71, 72, 73, 74, and 75 are transmitted sequentially, whereof the window frame 72 and 75 include the specific sign S. If data 123 is desired to be transmitted, the window frame 72 is sent out at time F1 and the window frame 75 is sent out at time F2 to make F2−F1=123.

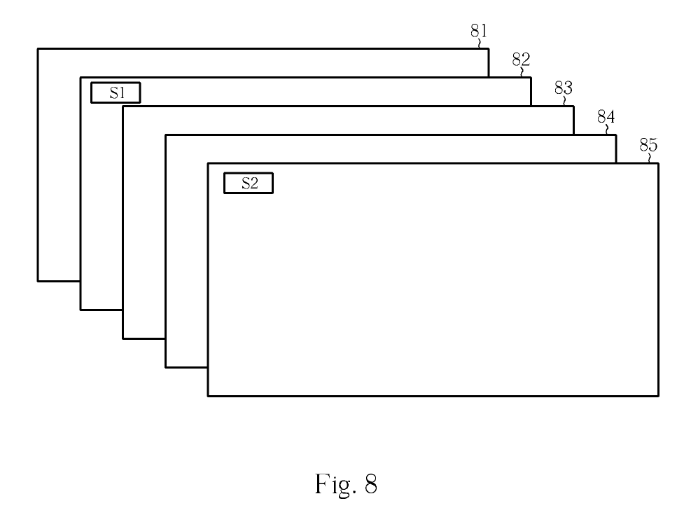

Please refer to FIG. 8 and FIG. 3. FIG. 8 is a diagram illustrating the repetition filter in FIG. 3. As shown in FIG. 8, a plurality of window frames 81, 82, 83, 84, and 85 are transmitted sequentially, whereof each window frame include a serial number. Different data includes different serial numbers, whereof the serial number of the window frame 82 is S1 and the serial number of the window frame 85 is S2. If the serial number S2=S1, then the window frame 85 is discarded.

The above-mentioned embodiments illustrate but do not limit the present invention. The location filter, the space hiding filter, the watermark filter, the temporary filter, and the repetition filter are used for picking the signature signal from window frames, but types of the signal filters are not limited and can be other types. Furthermore, the watermark filter is not restricted to put the signature signal in the R₀-R₂, G₀-G₂, and B₀-B₁ bits only, and can be adjusted depending on signal size and characteristics.

In conclusion, the present invention provides a method and related apparatus for hiding data inside video signals and transmitting the video signals to a display device. The signature signal is hidden in the window frame to be transmitted first, and the signature signal is picked from the window frame through miscellaneous signal filters. Due to the signature signal being hidden in the invisible region of the window frame or in the LSB of a pixel, it has little effect on the original signal content making it difficult for users to observe it. Furthermore, no extra connection lines and connection devices (such as USB devices) are required if data between the host and the display device of the computer system is transmitted though the DDC/CI interface, which will not only reduce cost but also improve convenience for the users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for hiding data inside video signals and transmitting the video signals to a display device, the method comprising:
(a) detecting whether a signature signal is attached to a window frame;
(b) picking the signature signal from the window frame when detecting the signature signal is attached to the window frame;
(c) generating a control signal according to the signature signal; and
(d) acting correspondingly on the display device according to the control signal.

2. The method of claim 1, further comprising:
continuing detecting whether the signature signal is attached to a next window frame when detecting the signature signal is not attached to the window frame.

3. The method of claim 1, wherein the step (c) comprises:
transmitting the picked signature signal to a microprocessor to generate the control signal.

4. The method of claim 1, wherein the step (b) comprises:
utilizing a signal filter to pick the signature signal from the window frame.

5. The method of claim 4, wherein the step of utilizing the signal filter to pick the signature signal from the window frame comprises:
utilizing a first location in the window frame to obtain a first notation, whereof the first notation used for indicating a second location of a second notation, and then finding the second location in the window frame to obtain the second notation according to the first notation;
wherein the first notation and the second notation form the signature signal.

6. The method of claim 4, wherein the step (a) comprises:
detecting whether the signature signal hides beyond a visible region of the display device.

7. The method of claim 6, wherein the step of utilizing the signal filter to pick the signature signal from the window frame comprises:
picking the signature signal hidden outside the visible region of the display device from the window frame.

8. The method of claim 4, wherein the step (a) comprises:
detecting whether the signature signal hides in the last significant bit (LSB) of three bytes of a pixel in the window frame.

9. The method of claim 8, wherein the step of utilizing the signal filter to pick the signature signal from the window frame comprises:
picking the signature signal hidden in the last significant bit (LSB) of the three bytes of the pixel from the window frame.

10. The method of claim 4, wherein the step (a) comprises:
determining whether the signature signal is detected within a period of a designed frequency.

11. The method of claim 10, wherein the step of utilizing the signal filter to pick the signature signal from the window frame comprises:
when the signature signal is detected within the period of the designed frequency, decoding the window frame to obtain the signature signal according to the designed frequency.

12. The method of claim 1, further comprising:
(e) discarding an image information with repetition number when receiving the image information with repetition.

13. The method of claim 1, further comprising:
(f) transmitting the control signal to a scaler for selectively processing size adjustment or image setting.

14. A display device that hides data inside video signals, the display device comprising:
a signal filter, having an input end for receiving a window frame and picking a signature signal from the window frame; and
a microprocessor, having an input end coupled to a first output end of the signal filter and an output end for outputting a control signal according to the signature signal;
wherein the display device acts correspondingly according to the control signal.

15. The display device of claim 14, further comprising:
a scaler, having a first input end coupled to a second output end of the signal filter for receiving the control signal, and an output end used for generating a display signal, the scaler used for selectively processing size adjustment or image setting according to the control signal.

16. The display device of claim 14, wherein the signal filter is a location filter, which utilizes a first location in the window frame to obtain a first notation, whereof the first notation used for indicating a second location of a second notation, and then finds the second location in the window frame to obtain the second notation according to the first notation, wherein the first notation and the second notation form the signature signal.

17. The display device of claim 14, wherein the signal filter is a space hiding filter, the signal filter used for lessening ranges of the display signal and hiding the signature signal outside a visible region of the display device.

18. The display device of claim 14, wherein the signal filter is a watermark filter, the signal filter used for picking the signature signal hidden in the last significant bit (LSB) of three bytes of a pixel from the window frame.

19. The display device of claim 14, wherein the signal filter is a temporary filter, the signal filter used for decoding the window frame to obtain the signature signal according to a designed frequency when the signature signal is detected within a period of the designed frequency.

20. The display device of claim 14, wherein the signal filter is a repetition filter, the signal filter used for discarding an image information with repetition number when receiving the image information with repetition.
